(19) United States
(12) Patent Application Publication
(10) Pub. No.: US 2005/0046615 A1
(43) Pub. Date: Mar. 3, 2005

(54) Display method and apparatus for navigation system

(76) Inventor: Maung W. Han, Torrance, CA (US)

Correspondence Address: MURAMATSU & ASSOCIATES, Suite 225, 7700 Irvine Center Drive, Irvine, CA, 92618, US

(21) Appl. No.: 10/652,758

(22) Filed: Aug. 29, 2003

(51) Int. Cl. G01S 1/00; G08G 1/123; H04Q 7/00; G01C 21/34

(52) U.S. Cl. 342/357.06; 342/357.1; 342/357.09; 342/357.13; 342/357.01; 340/990; 340/995.13; 340/7.55; 701/201; 701/213; 701/200

(57) ABSTRACT

A display method and apparatus for navigation system enables a user to quickly view zoomed images by using a radial scaling method. The display method includes the steps of: reading out map data from a map data storage for displaying a map image on a screen of a navigation system; converting the map data to screen coordinates so that an intended map image is displayed on a correct position on the screen; zooming the map image by enlarging or shrinking distances of points on the map image relative to a center of the screen; and storing the map data converted to the screen coordinates in a memory for use with a further operation of changing the map scale.

### FIELD OF THE INVENTION

This invention relates to a display method and apparatus for navigation system, and more particularly, to a display method and apparatus which is capable of easily and quickly zooming a map image on a display screen of the navigation system by radially scaling the map image relative to a center of the display screen.

### BACKGROUND OF THE INVENTION

A navigation system performs travel guidance for enabling a user to easily and quickly reach the selected destination. A typical example is a vehicle navigation system where a navigation system is equipped in a vehicle to assist a user (driver) to smoothly travel to the destination. Such a navigation system detects the position of the user or user's vehicle, reads out map data pertaining to an area at the current vehicle position from a data storage medium, for example, a CD-ROM (compact disc read-only memory), a DVD (digital versatile disc), or a hard disc. Alternatively, such map data can be provided to the user from a remote server through a communication network such as Internet.

When a destination is set, the navigation system starts a route guidance function for setting a guided route from the start point to the destination. To determine the guided route to the destination, the navigation system calculates and determines an optimum route to the destination based on various parameters. For example, the guided route is determined based on the shortest way to reach the destination, the route preferring freeways to local streets, the least expensive way to the destination, or the route without using toll road, and the like.

During the route guidance, the navigation system reads the nodes data from the data storage medium such as DVD and successively stores the nodes data of road segments (expressed in longitude and latitude) constituting the guided route in a memory. In the actual traveling, the node series stored in the memory is searched for a portion of the guided route to be displayed in a map display area of the monitor screen, and the portion of the guided route is highlighted so as to be discriminable from other routes. When the vehicle is within a predetermined distance of an intersection it is approaching, an intersection guidance diagram (an enlarged or highlighted intersection diagram with an arrow indicating the direction in which the vehicle is to turn at the intersection) is displayed to inform a user of the desired one of roads or directions selectable at the intersection. Such route guidance by the navigation system is also given by voice instruction.

Typically, a navigation system includes a map zoom function so that a user can see a detailed map image and associated information such as point of interest (POI) icons on the map image. FIGS. 1A-1C show an example of such a map zoom function depicted on a navigation screen where a map scale on the screen is changed in response to a zoom key (not shown). Since the recent navigation system enables a user to specify a destination by pointing a location on the map image or selecting a POI icon on the map image, the zoom function is one of the essential features of the navigation system.

In FIGS. 1A-1C, as is well known in the art, when pressing a zoom key, the map scale is either increased or decreased continuously relative to a cursor point. By operating the zoom key to display a wider area in the screen of FIG. 1B than that of FIG. 1A, i.e., by zooming-out, the places outside of the screen of FIG. 1A become visible within the screen view 21 of FIG. 1B. Accordingly, the user can bring the desired place within the screen by displaying the larger area in one screen in combination with a screen scroll function of the navigation system, thereby selecting a destination. Alternatively, by operating the zoom key, a small area around the cursor point in the screen of FIG. 1A can be enlarged, i.e., by zooming-in the image, as shown in FIG. 1C.

The above noted zoom operation is conducted in the conventional navigation system in a manner shown in the functional diagram of FIG. 2. The map information extracted from a storage media 31, such as a DVD (digital versatile disc), CD-ROM (compact disc-read-only memory), or hard disk, is stored in a map memory 31. If a map mode is selected, then the display controller 32 reads the map data from the map memory 31 or from the DVD 31. The display controller 32 de-normalizes the map data to display the map image with a selected map zoom scale by a de-normalizing and scaling unit 33. Then, the coordinates of the scaled data are converted to screen coordinates by linearly offsetting the coordinates by an offset unit 34.

If a zoom scale is changed, the display controller 32 will access the map memory 31 to read out the map data corresponding to the zoom scale. Then, the display controller 32 de-normalizes and scales the normalized map data, and converts them to the map data with respect to the screen coordinates. Finally, the zoomed map image is displayed on the screen.

As described in the foregoing, the process of displaying a map image is relatively complicated. Especially, the zoom process takes time because this process contains steps of reading the map data from the map memory or from the DVD every time when the zoom mode is activated, the de-normalizing and scaling process has to be conducted, and then finally the map data is converted with respect to the screen coordinates.

As a consequence, sometimes, the user has to wait for a long time until the map data is zoomed with the specified zoom scale. Therefore, this burdensome operations may affect the safe driving. Thus, a capability of zooming a map image more smoothly and promptly is a fundamental need for a navigation system which enables the user to quickly see a zoomed view of a detailed or broad map information.

### SUMMARY OF THE INVENTION

It is, therefore, an object of the present invention to provide a display method and apparatus for navigation system which is capable of zooming the map image at high speed without need to access the map data each time.

It is another object of the present invention to provide a display method and apparatus for navigation system which is capable of zooming the map image through a radial scaling relative to a center of the monitor screen.

It is a further object of the present invention to provide a display method and apparatus for navigation system which is capable of easily changing the map scale and finding a destination on the screen.

The display method and apparatus of the present invention eliminates need of repeating an initial data preparation step to retrieve map data from a map data storage. Thus, the initial data displayed on a screen are stored in a memory, and the stored data are used for the next zoom operation. When zooming-in the map image, the display method uses only the stored data in the memory to display. When zooming-out the map image, the display method may need additional data in the map data storage. However, the size of the additional data is small because the additional data are used only for filling in a surrounding area, not for the whole screen, thus, a zooming time is much shorter than that required in the conventional zooming method.

More specifically, the display method includes the steps of reading out map data from a map data storage for displaying a map image on a screen of a navigation system, converting the map data to screen coordinates so that an intended map image is displayed on a correct position on the screen, zooming the map image by enlarging or shrinking distances of points on the map image relative to a center of the screen, and storing the map data converted to the screen coordinates in a memory for use with a further operation of changing the map scale.

The display method further includes a step of reading out the map data from the memory and multiplying a map scale value which is larger than one, thereby enlarging the map image on the screen. Similarly, the display method further includes a step of reading out the map data from the memory and multiplying a map scale value which is smaller than one, thereby shrinking the map image on the screen.

In shrinking the map image, the display method further includes the steps of reading out additional map data from the map data storage when the map data stored in the memory is insufficient, converting the additional map data with respect to the screen coordinates, combining the map data from the memory with the converted additional map data, and displaying the map image encompassing a larger area than that covered by the original map image.

When zooming the map image, the display method includes a step of positioning an area of interest on the map image to the center of the screen. When specifying a destination, the display method further includes the steps of positioning an area of interest on the map image to the center of the screen, zooming-in the map image to a degree that new information for selecting a destination is displayed on the screen, and selecting the destination using the new information on the screen to calculate a route to the destination.

Another aspect of the present invention is a display apparatus for quickly zooming the map image on the navigation system. The display apparatus is constituted by various means for achieving the display method described above in which the radial scaling method is conducted.

According to the present invention, the display method and apparatus is able to provide a user a zoomed image very quickly by using the radial scaling method. In the radial scaling method, the map image is either enlarged or shrunk relative to the center of the display screen. In the present invention, it is unnecessary to access the memory and retrieve new map data each time when the zooming operation is conducted. Thus, the zooming operation is conducted at high speed. Even when additional map data has to be acquired, such as when zooming-out the map image, the amount of new data required is much smaller than that required in the conventional technology, thereby achieving the zooming operation at high speed.

### BRIEF DESCRIPTION OF THE DRAWINGS

FIGS. 1A-1C are schematic diagrams showing an example of map zooming operation in a navigation system where a map image of FIG. 1A is zoomed-in in FIG. 1B and zoomed-out in FIG. 1C.

FIG. 2 is a functional block diagram showing the structure for displaying the map image and zooming the map image in the conventional technology.

FIG. 3 is a block diagram showing an example of structure of a vehicle navigation system for implementing the display method and apparatus of the present invention.

FIGS. 4A-4B are diagrams showing an example of outer appearance of a remote controller accompanied by the navigation system of FIG. 3.

FIGS. 5A-5C are schematic diagrams showing the process and relationship between zooming process and display coordinates in the navigation system.

FIGS. 6A-6B are schematic diagrams showing a concept of a zooming method of the present invention and a process for converting the map scale by zooming-in the map image in the navigation system of the present invention.

FIGS. 7A-7B are schematic diagrams showing a concept of the radial scaling in the present invention where the map scale is changed relative to a center of the display.

FIG. 8 is a functional block diagram showing the structure of the display apparatus for displaying the map image by incorporating the radial scaling function in the present invention.

FIGS. 9A-9B are schematic diagrams showing an example of process in the zooming-in operation with respect to the display coordinates and the scale factor.

FIGS. 10A-10B are schematic diagrams showing an example of process in the zooming-out operation for the map data acquired in the manner of FIG. 5A.

FIGS. 11A-11B are schematic diagrams showing an example of zooming-in the map image using the map data in about a center area of the map memory.

FIGS. 12A-12C are schematic diagrams showing an example of process of zooming-out the map image for the map data acquired in the manner of FIG. 11A.

FIGS. 13A-13F are schematic diagrams showing screen examples for selecting a destination in the navigation system using the radial zooming of the present invention.

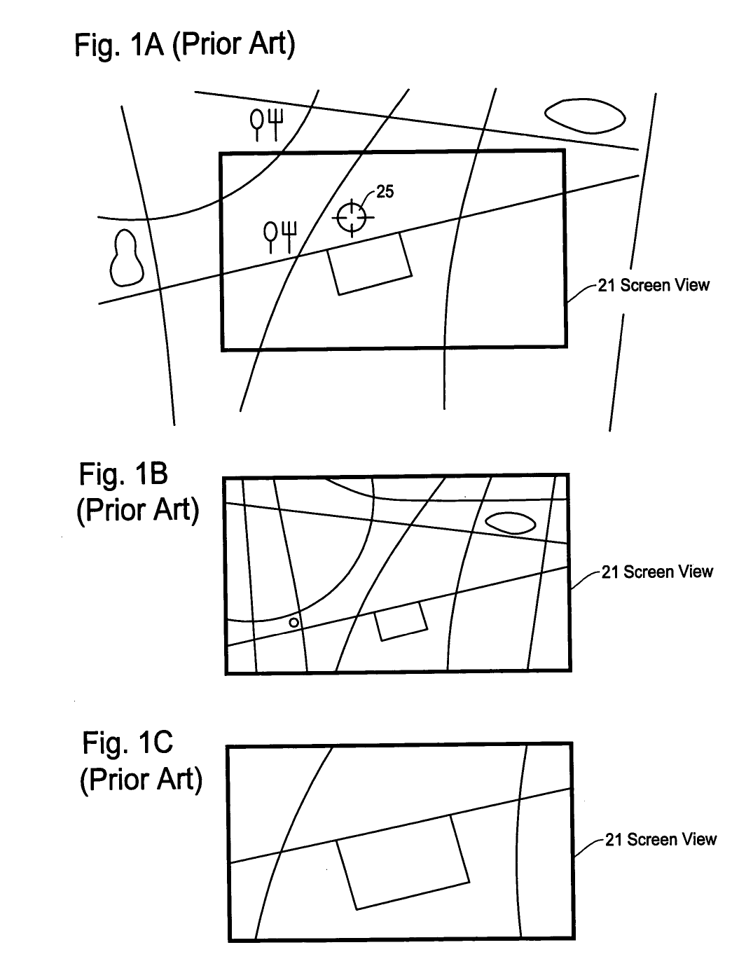

### DETAILED DESCRIPTION OF THE INVENTION

The present invention will be described in detail with reference to the accompanying drawings. The navigation system of the present invention is designed to enable a user to quickly observe the zoomed views which provide broad or detailed views of the map information. The zooming operation is conducted with respect to a center of the display screen so that the map data in the map memory is fully utilized during the zooming operation without requiring every time to access to a map data storage such as a DVD.

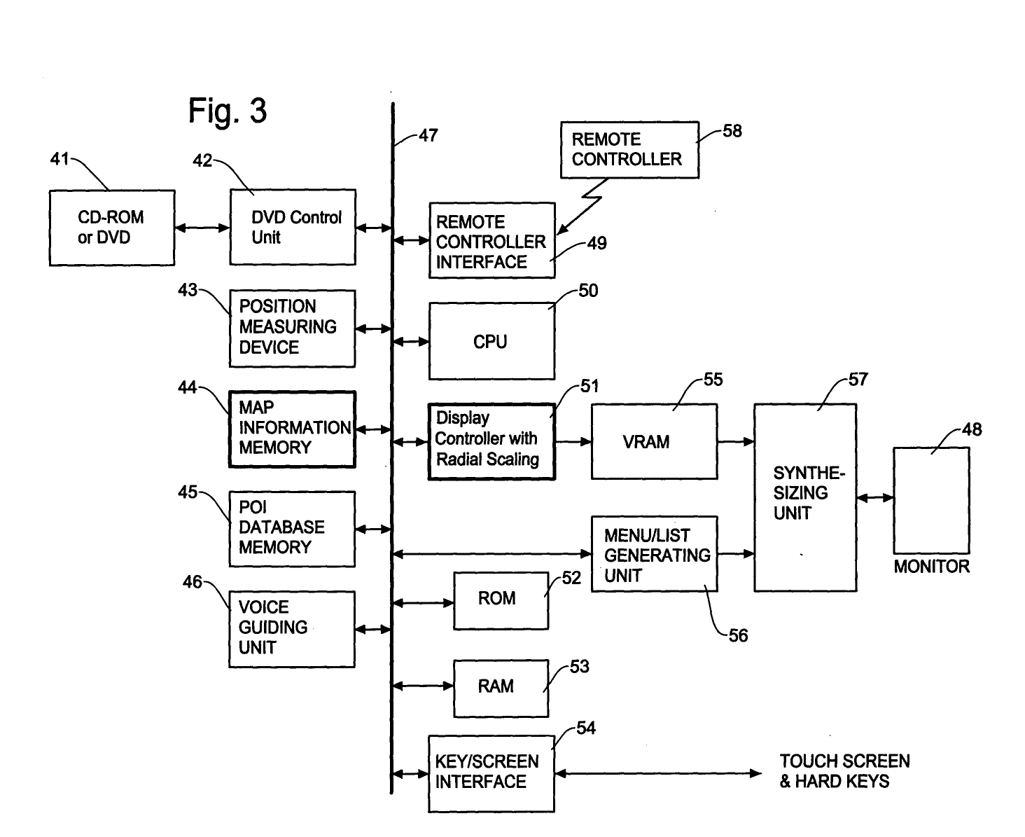

FIG. 3 shows a block diagram of the navigation system in the present invention. While the vehicle navigation system is explained for an illustration purpose, the present invention can also be applied to other types of navigation system such as a portable navigation device implemented by a PDA (personal digital assistant) device or other hand-held devices.

The navigation system includes a map storage medium 41 such as a CD-ROM, DVD, hard disc or other storage means (Hereafter “DVD”) for storing map information, a DVD control unit 42 for a controlling an operation for reading the map information from the DVD, a position measuring device 43 for measuring the present vehicle position. The position measuring device 43 has a vehicle speed sensor for detecting a moving distance, a gyro for detecting a moving direction, a microprocessor for calculating a position, a GPS receiver, and etc.

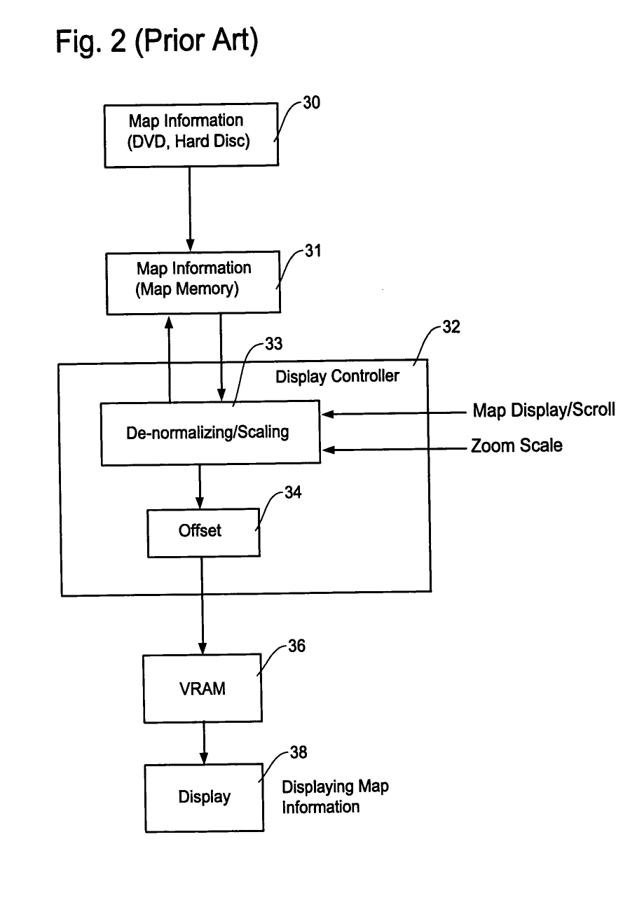

The block diagram of FIG. 3 further includes a map information memory 44 for storing the map information which is read out from the DVD 21, a POI database memory 45 for storing database information such as a point of interest (POI) which is read out from the DVD 41, a remote controller 48 for executing a menu selection operation, an enlarge and reduce operation, a destination input operation, etc. and a remote controller interface 49. The map information memory 44 corresponds to the map memory 31 in FIG. 2.

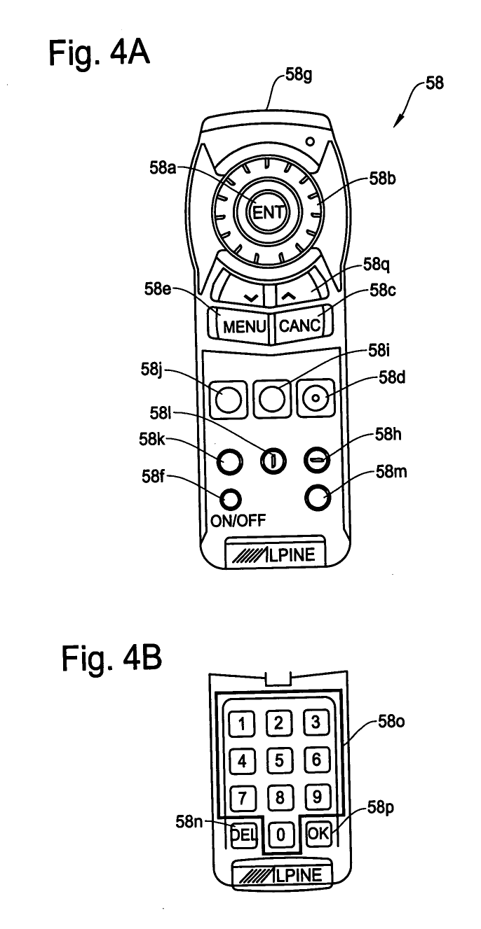

The remote controller 58 has a variety of function keys as shown in FIG. 4A and numeric keys as shown in FIG. 4B.

The numeric keys appear when a lid in the lower part of FIG. 4A is opened. The remote controller 58 includes a joystick/enter key 58a, a rotary encoder 58b, a cancel key 58c, an MP/RG key 58d, a menu key 58e, a zoom/scroll key 58q, a monitor ON/OFF key 58f, a remote control transmitter 58g, a plan key 58h, an N/H key 58i, a voice key 58j, a list key 58k, a detour key 58l, a delete destination key 58m, a delete key 58n, numeric keys 580, and an OK key 58p.

The joystick/enter key 58a selects highlighted items within the menu and moves map displays and a vehicle position icon. The rotary encoder 58b changes zoom scale, scrolls list pages, moves the cursor, and etc. The cancel key 58c cancels the present displayed screen or is operated when returning the screen to the previous menu screen. The MP/RG key 58d toggles between detailed map display and basic guide display during guidance. The menu key 58e displays the main menu. The plan key 58h starts the route guidance including two or more destinations, the N/H key 58i changes between north-up and heading-up orientations, and the voice key 58j initiates voice instruction.

Although a remote controller such as described above is a typical example for selecting menus, executing selected functions and etc., the navigation system includes various other input methods to achieve the same and similar operations done through the remote controller. For example, the navigation system includes hard keys and a joystick on a head unit of the navigation system mounted on a dash board, touch screen of the display panel, and voice communication means.

The navigation system further includes a bus 47 for interfacing the above units in the system, a processor (CPU) 50 for controlling an overall operation of the navigation system, a ROM 52 for storing various control programs such as a route search program and a map matching program necessary for navigation control, a RAM 53 for storing a processing result such as a guide route, a voice interface and guiding unit 46 for voice communication interface and spoken instructions, a display controller 51 for generating, scrolling and zooming a map image (a map guide image and an arrow guide image) on the basis of the map information, a VRAM 55 for storing images produced by the display controller, a menu/list generating unit 56 for generating menu image/various list images, a synthesizing unit 57, a monitor (display) 48 and a key and screen interface 54 for interfacing with various other input means such as hard keys and joystick on a display panel of the navigation system, and the like.

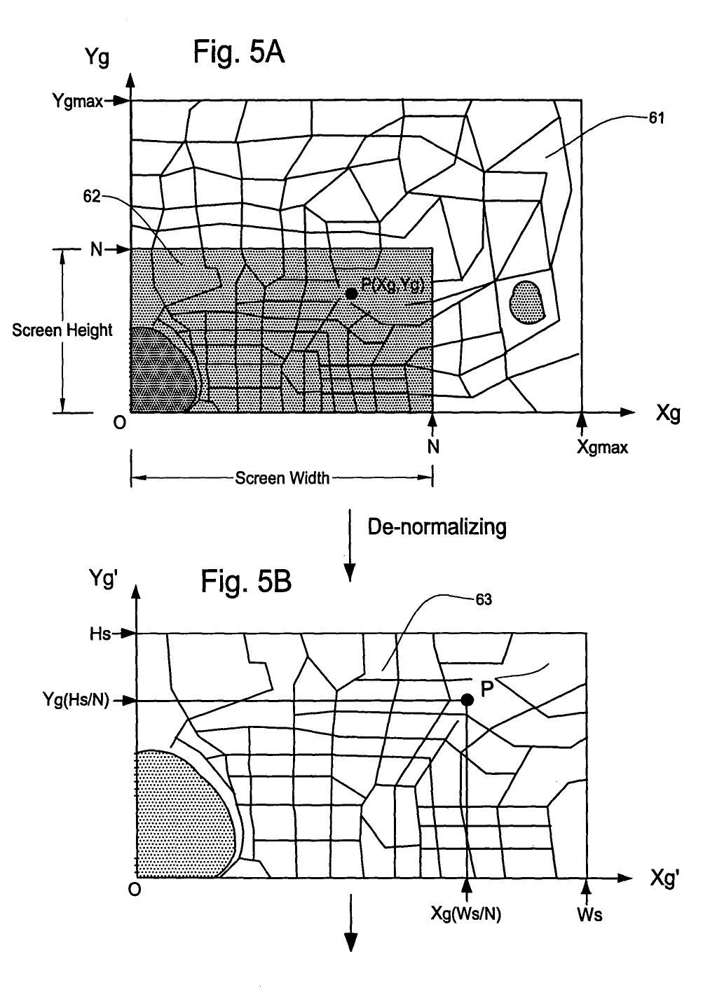

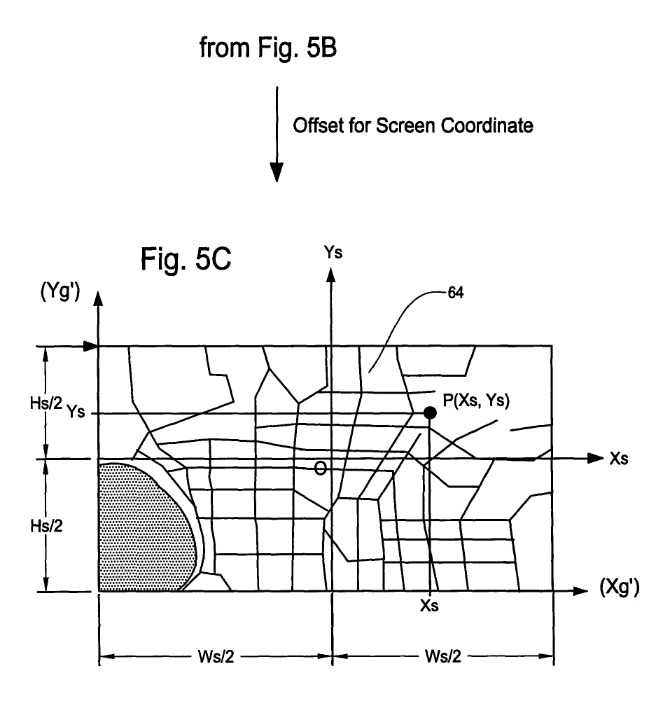

In this example, the display controller 51 includes a radial scaling function for zooming-in and zooming-out the map image in the present invention. As will be explained in detail later, the radial scaling is to change the map scale relative to a center of the display screen. Thus, the map data in the map memory 44 is fully utilized during the zooming operation without requiring to access to the DVD 41 every zooming operation. Preferably, the display controller 51 includes a buffer memory to store the processed map data which is used in the zooming operations. The detailed description regarding the radial scaling is given with reference to FIGS. 5-11.

FIGS. 5A-5C showing an example of data processing to convert from normalized map data to de-normalized map data and to offset the map data for display. FIG. 5A is a schematic diagram showing map image data in a map memory, for example, the map information memory 44 in FIG. 3, which is extracted from the data source such as the map data storage (DVD, CD-ROM, hard disc) 41 of FIGS. 3. The data area 61 shows an area of map data stored in the map memory which is larger than the data required for one screen area (view area) 62 of the navigation monitor screen.

The coordinates of the map data in the map information memory is expressed by normalized coordinates X_{g} and Y_{g}. For simplicity of explanation, FIG. 5A shows the case where the map data for the screen area 62 is retrieved from the boundary of coordinates of the data area 61. In the example of FIG. 5A, a label “P” indicates an arbitrary point in the screen data area 62 having X_{g} and Y_{g} components of the normalized coordinates.

The map data for the screen area 62 is de-normalized as shown in FIG. 5B. The de-normalized map data is expressed with respect to de-normalized coordinates X_{g}′ and Y_{g}′. In this example, it is assumed that the map image is not zoomed yet, i.e. a zoom scale=1. Accordingly, X and Y components of the point “P” is expressed respectively by X_{g}(Wₛ/N) and Y_{g}(Hₛ/N), where N represents a normalization coefficient, Wₛ represents a screen width and Hₛ represents a screen height. Thus, the normalized screen area in FIG. 5A is scaled to fit with the actual screen area having the width Wₛ, and height Hₛ. as shown in FIG. 5B.

Further, the coordinates of the converted map data in FIG. 5B is offset to convert to Xₛ and Yₛ screen coordinates as shown in FIG. 5C. A center of the screen coordinates “O” is coincident with a center of the navigation screen. In this example, the Xₛ and Yₛ coordinates of the arbitrary point P are expressed by the following simple equations:
Xₛ=X_{g}(Wₛ/N)−Wₛ/2
Yₛ=Y_{g}(Hₛ/N)−Hₛ/2

By the above equations, the values of the offset are respectively, −Wₛ/2 for X coordinate and −H/2 for Y coordinate. Thus, by offsetting the X_{g}′ and Yₛ′ coordinates with these values, the map data is converted to the Xₛ and Yₛ screen coordinates.

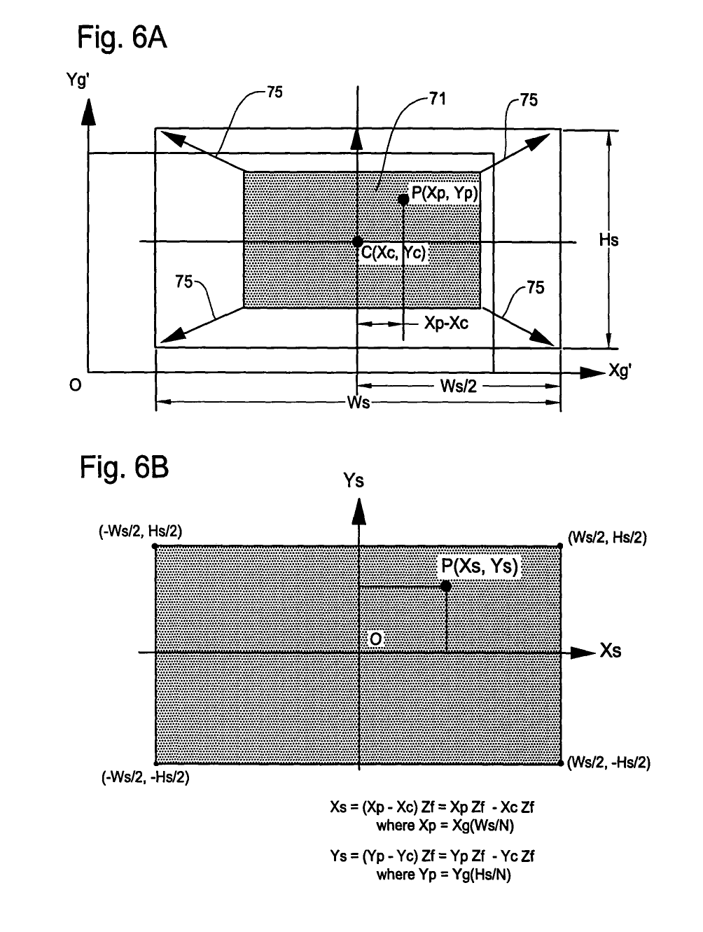

The zoom operation is activated when the user moves the image of an area of attention to the center of the screen and sends a zoom command (zoom scale) to the navigation system. With reference to FIGS. 6A-6B, a zoom operation after de-normalizing and scaling the map data is explained. The point C(X_{c}, Y_{c}) indicates a center of zooming and the point P(Xₚ, Yₚ) indicates an arbitrary point in a shaded area 71 which is enlarged to the size of the screen (Wₛ×Hₛ). As described with reference to FIGS. 5A-5C, the coordinates Xₚ and Yₚ are Xₚ=X_{g}(Wₛ/N) and Yₚ=Y_{g}(Hₛ/N), respectively.

In the present invention, the zoom operation is conducted in expanding or shrinking the map image in the radial directions with respect to the center C(X_{c}, Y_{c}) of the screen. In FIG. 6A, the radial directions are denoted by arrows 75 which show that the area 71 is enlarged to the screen of FIG. 6B by a zoom scale Z_{f}. The zoom scale Z_{f} is larger than 1 when zooming-in the map image. In order to zoom-in the area 75, a distance between the arbitrary point P and the center C is multiplied by the zoom scale Z_{f}.

By implementing the same calculation, i.e., multiplying the zoom scale Z_{f} with all the points contained in the area 71, the display controller 51 produces the zoomed map data in the Xₛ and Yₛ screen coordinates as shown in FIG. 6B. An arbitrary point P(Xₛ, Yₛ) is expressed by the following equations:
Xₛ=(X_{P}−X_{c}) Z_{f}=XₚZ_{f}−X_{c}Z_{f}
Yₛ=(Yₚ−Y_{c})Z_{f}=YₚZ_{f}−Y_{c}Z_{f}

Although FIGS. 6A-6B show the process of zooming-in, the above equations can be applied to a process of zooming-out by using the zoom scale Z_{f} which is smaller than 1. Thus, mathematically, the zoom-in process and the zoom-out process are expressed by the same formula as noted above.

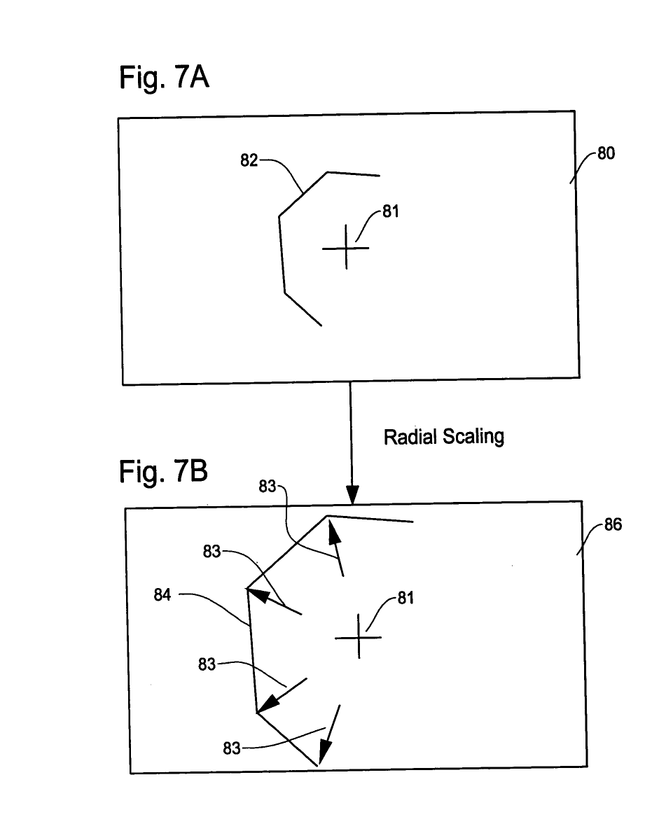

FIGS. 7A-7B show a concept of a radial scaling in the map zooming of the present invention. Referring to FIG. 7A, a cross mark 81 indicates a center of a screen 80 and there is an arbitrary object 82 on the screen 80. To make an algorithm of calculation simple, a zoom operation is implemented with respect to the center 81. For example, when the process of zooming-in as shown in FIG. 7B, the arbitrary object 82 is enlarged in radial directions 83 by moving away from the center 81. Similarly, in the process of zooming-out, the arbitrary object 82 is reduced in radial directions by moving toward the center 81. Since the radial scaling does not need to acquire any new map data from the data source (DVD 41) when zooming-in, the zooming operation can be conducted at high speed. Even in the zooming-out operation, since the map memory 44 stores the map information which covers the area 61 much larger than the screen size 62 as shown in FIG. 5A, it is only necessary to acquire new map data when the existing map data in the map memory 44 is insufficient, as will be described in more detail later.

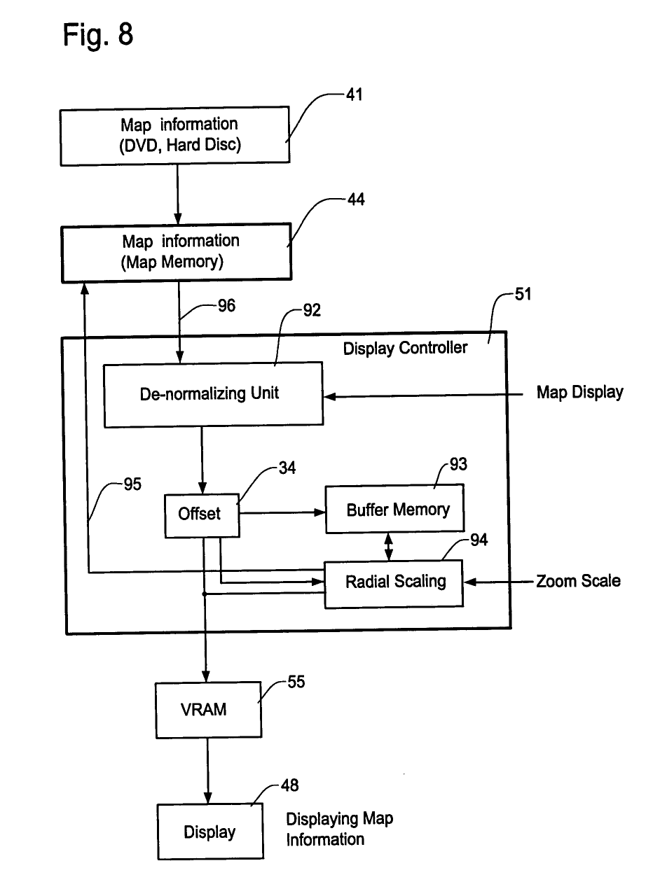

FIG. 8 shows a functional block diagram for displaying the map image using the radial scaling method of the present invention. The components in FIG. 8 correspond to the components in the block diagram of FIG. 3. The display controller 51 includes the function blocks of a de-normalizing unit 92, an offset unit 34, a buffer memory 93 and a radial scaling unit 94. The display controller 51 reads the normalized map information data form the map memory 44 which is extracted from the map storage medium (DVD) 41. The de-normalizing unit 92 in the display controller 51 converts the coordinates of the map data to the screen coordinates. The offset unit 34 offsets the map data to match the navigation screen.

After the above processes of converting the coordinates of the map information data to the screen coordinates and offset the same, the converted data are stored in the buffer memory 93 to be used for the next zooming process of radial scaling. Alternatively, the display controller 51 controls to store all the map data for the area 61 (FIG. 5A) from the map memory 44 in the buffer memory 93 including the map data de-normalized and offset for the screen size 62 (FIG. 5A). Further, the buffer memory 93 can be replaced with the map memory 44 so that the map memory plays the role of the buffer memory of the present invention as well. Namely, one memory for temporarily store the map data is sufficient for achieving the object of the present invention.

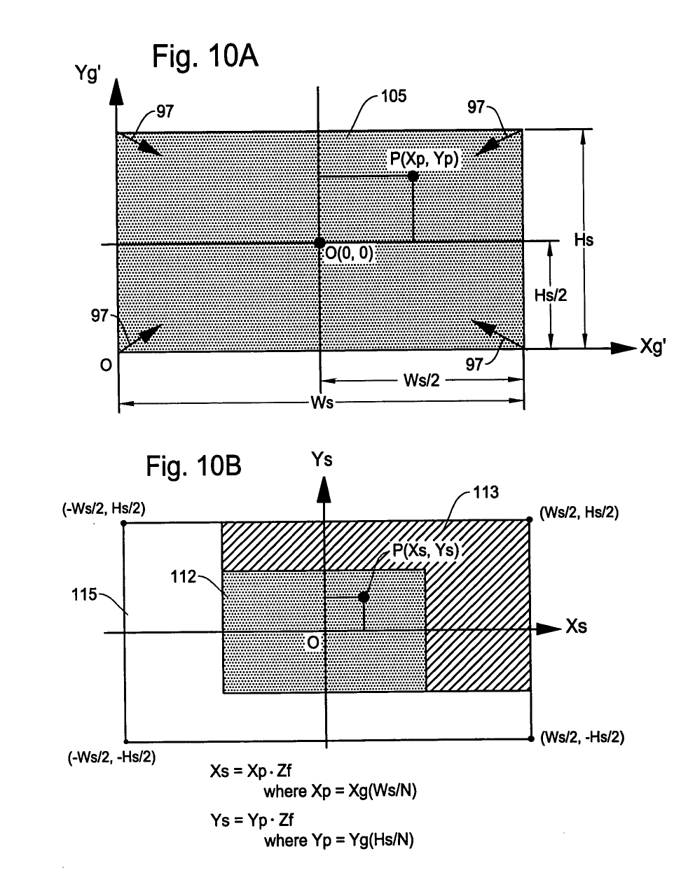

If there is a zoom request (change of zoom scale), the display controller 51 reads the data in the buffer memory 93 and implements the radial scaling calculation by the radial scaling unit 94. The radial scaled data is sent to the display monitor 48 through the VRAM 55 and displayed thereon. When zooming-in the map image, the display controller 51 simply implements the radial scaling. On the other hand, when zooming-out the map image, the display controller 51 may need to read minimal data from the map memory 44 or from the map data storage (DVD) 41 to fill in map information for the areas surrounding the existing area (ex. the area 61 of FIG. 5A). More detailed explanation for filling in the surrounding area will be described later with reference to FIGS. 10A-10B, 11A-11B and 12A-12C.

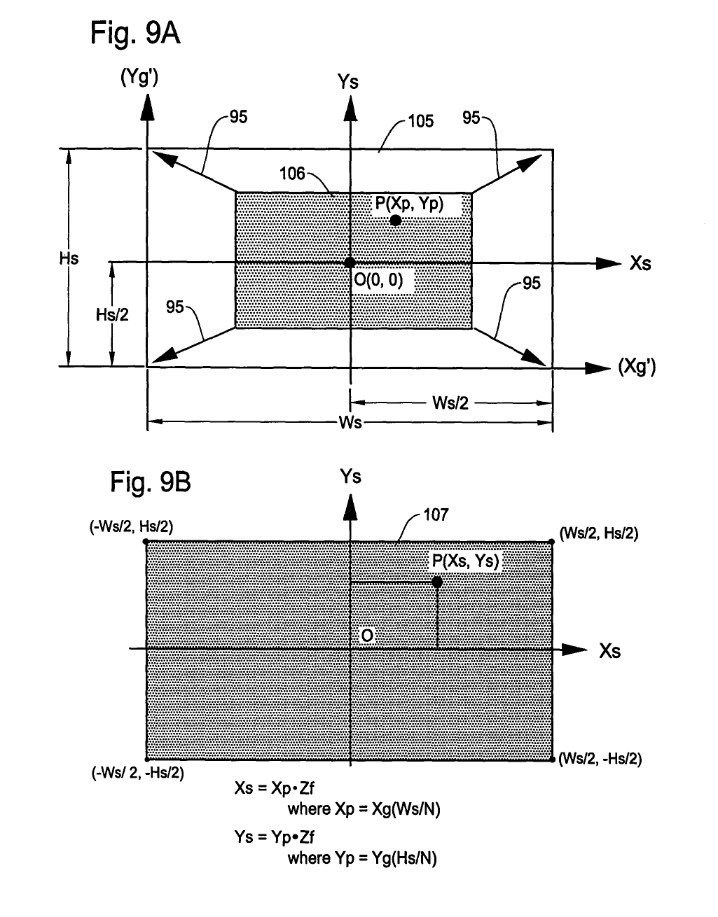

FIGS. 9A-9B show how the radial scaling is implemented when the map image is zoomed-in. Referring to FIG. 9A, there is the data area 106 which has been once displayed on the screen and stored in the buffer memory 93. The stored data area 106 are expressed in the Xₛ and Yₛ coordinates. The map image of the area 106 is enlarged (zoomed-in) with the zoom scale Z_{f} where Z_{f}>1, to an area 105 with the screen of Wₛ by Hₛ, where the center O of the area 105 is coincident with the center of the screen.

FIG. 9B shows an enlarged area 107 in the Xₛ and Yₛ coordinates, corresponding to the area 106 in FIG. 9A. Assuming that P(Xₚ, Yₚ) is an arbitrary point in the area 106, an arbitrary point P(Xₛ, Yₛ) in the enlarged area 107 corresponding to the point P(Xₚ, Yₚ) in the area 106 is expressed by the following formulas:
Xₛ=XₚZ_{f}
Yₛ=YₚZ_{f}
where Z_{f}>1

When the map image is zoomed-in as described above, the initial data preparation step to retrieve the map data from the map memory including de-normalizing and scaling process is eliminated because the map data in the screen coordinates are directly read out from the buffer memory 93. Since the map data for one full screen or greater is already exists in the buffer memory 93, there is no need to acquire new data from the map memory 44 or the map data storage (DVD) 41. Also, the access time to the buffer memory 93 is much shorter than that to the map data storage (DVD) 41 or the map memory 44. Therefore, the zooming-in process is conducted within a short period of time in the present invention.

FIGS. 10A and 10B show how the radial scaling is implemented when zooming-out the map image. Unlike the process of zooming-in, the process of zooming-out may need an additional process to retrieve the map data depending on the value of the zoom scale Z_{f}. If the value of zoom scale Z_{f} is small, map data corresponding to the surrounding areas 113 (with line hatching) and 115 (without hatching) have to be added to the data for the screen area 112 (with dot hatching). The surrounding area 113 which corresponds to the area 61 of FIG. 5A is out of the data area stored in the buffer memory 93. Alternatively, the surrounding area 113 can be processed in the same manner as that of the screen area 112 in the functional block of FIG. 8 and already stored in the buffer memory 93.

In either case, since the map data for the area 115 is not stored in the buffer memory 93, and thus, has to be retrieved from the map memory 44 or from the map data storage (DVD) 41. Thus, in the block diagram of FIG. 8, the radial scaling unit 94 sends a signal 95 requesting the new map data for the surrounding area 115 to the map memory 44. Thus, the display controller 51 receives the new data 96 from the map memory 44. The new map data needs to be processed in the display controller 51 of FIG. 8 for de-normalizing and offsetting to match the navigation screen.

FIG. 10A shows an example of screen before zooming-out. The map data for the area 105 is already stored in the buffer memory 93. The stored data 105 is expressed in the Xₛ and Yₛ coordinates. The map image is reduced with the scale factor Z_{f}<1 such that the area 105 in FIG. 10A is reduced to the area 112 in FIG. 10B. The center O of the area 112 is coincident with the center O of the screen.

The reduced area 112 is expressed in the Xₛ and Yₛ coordinates, corresponding to the area 105. Assuming that P(Xₚ, Yₚ) is an arbitrary point in the area 105, the arbitrary point P(Xₛ, Yₛ) in the reduced area 112 corresponding to the P(Xₚ, Yₚ) in the area 105 is expressed by the same formulas as above for the case of zooming-in, except that Z_{f}<1:
Xₛ=XₚZ_{f}
Yₛ=YₚZ_{f}
where Z_{f}<1

In order to complete the process of zooming-out, the surrounding area 113 needs to be filled with the additional map data. As described before, the display controller 51 acquires the map data for the area 113 from the map memory 44 and implements de-normalizing and scaling, and offsetting process. Alternatively, the display controller 51 has already performed the de-normalizing and offsetting process for the map data of the area 113 as well as the screen area 112 at the same time in the process of FIG. 5A-5C. At any rate, the map data for the area 115 must be acquired and processed for the zooming-out operation. At the same time, the display controller 51 combines the newly acquired data with the existing data in order to send the combined data to the monitor 48.

The time for the zooming-out operation in the present invention is shorter than the time for the conventional zoom-out operation because the amount of data to be processed is smaller than that required in the conventional technology. In the present invention, the zooming-out operation needs a time for the radial scaling of only the surrounding map area 115 from the map memory 44. In the conventional technology, new map data for the overall area involved in the zooming-out must be retrieved from the map data storage (DVD) 41 and processed. Thus, the time required for the radial scaling of the present invention is much shorter than that required for the conventional zooming-out process.

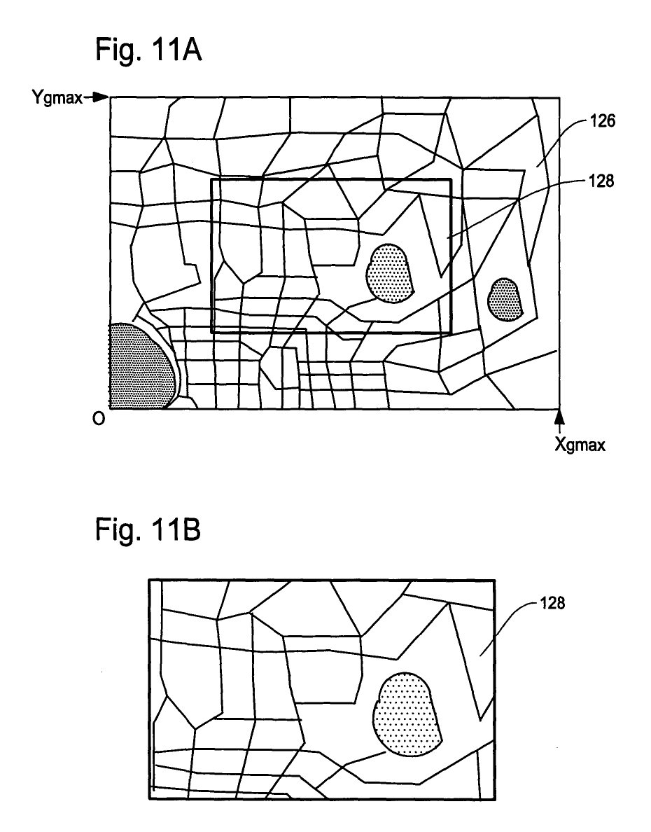

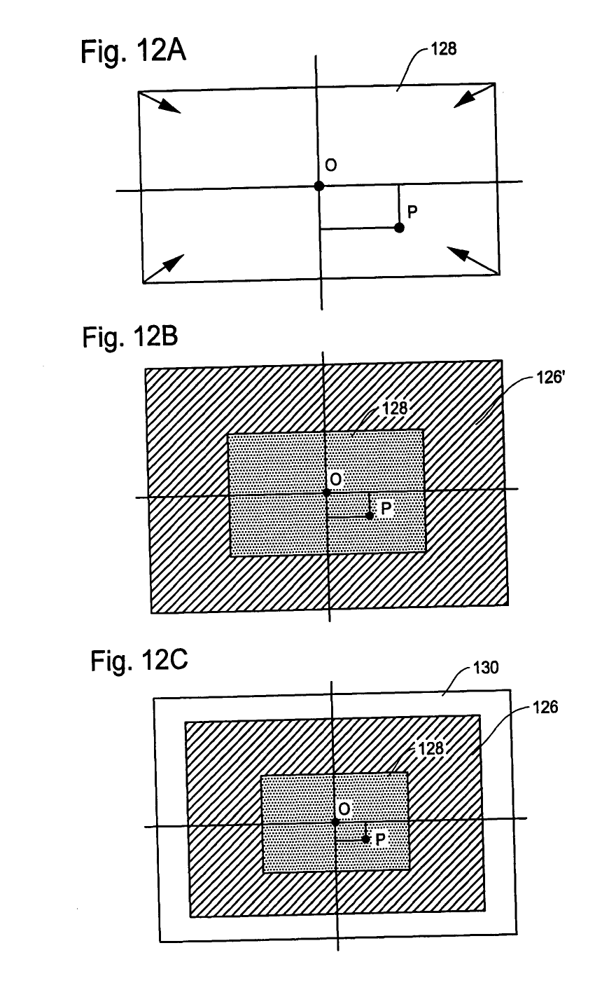

FIGS. 11A-11B and 12A-12C show another example of zooming-out operation in the present invention. This example shows the case where the map data for the area 126 is retrieved for displaying the map image for the area 128 from the map data storage (DVD) 41. In other words, for displaying the map image of the center area 128, the map data for the surrounding area 126 which is mach larger than the center area 128 is retrieved. The retrieved map data may be stored either in the map memory 44 or the buffer memory 93 of FIG. 8.

Thus, in the zooming-out operations of FIGS. 12A-12C, such map data for the surrounding area 126 can be used, as is, without need of acquiring the new data. For example, in the example of zooming-out the map image of FIG. 12A to the map image of FIG. 12B, if the zoom scale is not very small, the map data for the surrounding area 126 of FIG. 11A is sufficient to cover the displayed area 126′. As noted above, the map data for the area 126 is processed and stored either in the map memory 44 or the buffer memory 93, there is no need of accessing the map data storage 41 such as DVD or processing the new map data. Thus, the zooming-out operation is conducted with a short time.

In the case where the zoom scale is small so that the map data for the area 126 is insufficient as shown in the case of FIG. 12C, the navigation system has to retrieve the new map data from the map data storage 41 such as DVD or hard disc for an area 130. Thus, it takes time for accessing the disc drive of the map data storage 41 and accessing the newly acquired map data. However, even in this situation, since the amount of new map data is small, the time required for the zooming-out operation is much smaller than that required for the conventional technology.

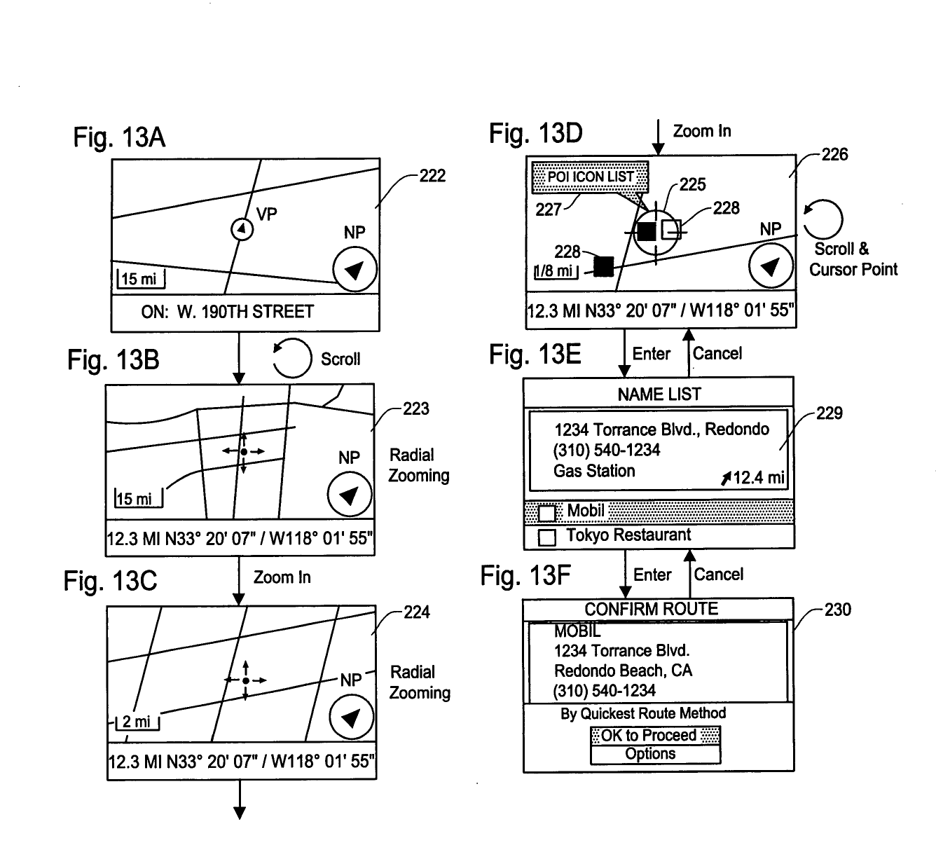

An example of application of the present invention is shown in FIGS. 13A-13F. When the user wants to select a destination by searching a point of interest (POI) on the map image, the radial zooming of the present invention is useful. The example of FIGS. 13A-13F show a case where the user wants to search a gas station through the map image. As noted above, the map image is zoomed with respect to the center of the screen. Therefore, after selecting the map mode, the user scrolls the map image and moves an area of attention at about the center of the screen before zooming.

FIG. 13A is an example of initial map image on the screen 222 in the map mode. In this example, the map image is displayed with an intermediate map scale “15 miles per ruler”. In FIG. 13B, the user scrolls the map image to move an area of interest to the center of the screen 223 by the cursor keys such as joystick 58a on the remote controller 58 (FIG. 4A). Thus, when the area of attention is centered in FIG. 13B, the user presses the zoom key 58q (FIG. 4A) to activate the zoom function of the navigation system. In the present invention, as noted above, the size of the map image is changed relative to the center of the screen as shown by the arrows of FIG. 13B.

Thus, in the screen 224 of FIG. 13C, the map image is zoomed-in so that the map image is enlarged from the center. In this example, the map scale is “2 miles per ruler” rather than “15 miles per ruler” of FIGS. 13A-13B. If the enlarged map image is not large enough, the user further presses the zoom key in FIG. 13C to further enlarge the map image with respect to the center of the screen. Thus, the map image is further enlarged as shown in the screen 226 of FIG. 13D where the map scale is “⅛ miles per ruler”.

The assignee of this invention provides a navigation system which is able to display POI (Point of Interest) icons when the map image is large enough. Thus, in FIG. 13D, POI icons 228 and a balloon message 227 will be displayed to prompt the user to examine the information regarding the POI icons. In this example, the balloon message 227 shows “POI ICON LIST” which means that the detailed information regarding the POI icons within the area specified by the cursor circle 225 is available. Typically, each icon indicates a category of POI to differentiate from other categories. Examples of such category include restaurant, bank, gas station, hotel, ATM (Automatic Teller Machine), and the like.

If the user wants to know more about the POIs in the cursor circle 225, then by pressing the enter key 58a, the navigation system will move to the brake down menu as shown in FIG. 13E. Here, the name list screen displays the names of the POIs specified by the cursor circle 225. In this example, the name “Mobile” is shown when selecting the POI icon indicating the gas station. At the same time, an information box 229 shows detailed information about the highlighted POI such as an address, phone number, direction and distance from the current vehicle position.

If the highlighted POI in the name list is the destination where the user wants to go, by pressing the enter key, the navigation system displays the confirmation screen 230. This screen is to confirm the place name shown on the screen as the user's destination. By further selecting a “OK to Proceed” menu, the navigation system calculates the route to the destination, thereby moving to the route guidance mode to guide the user to the destination.

As has been in the foregoing, the display method and apparatus of the present invention is able to provide a user a zoomed image very quickly by using the radial scaling method. In the radial scaling method, the map image is either enlarged or shrunk relative to the center of the display screen. In the present invention, it is unnecessary to access the memory and retrieve new map data each time when the zooming operation is conducted. Thus, the zooming operation is conducted at high speed. Even when additional map data has to be acquired, such as when zooming-out the map image, the amount of new data required is much smaller than that required in the conventional technology, thereby achieving the zooming operation at high speed.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A display method for a navigation system, comprising the following steps of:
reading out map data from a map data storage for displaying a map image on a screen of a navigation system;
converting the map data to screen coordinates so that an intended map image is displayed on a correct position on the screen;
zooming the map image by enlarging or shrinking distances of points on the map image relative to a center of the screen; and
storing the map data converted to the screen coordinates in a memory for use with a further operation of changing the map scale.

2. A display method for a navigation system as defined in claim 1, further comprising the step of:
reading out the map data from the memory and multiplying a map scale value which is larger than one, thereby enlarging the map image on the screen.

3. A display method for a navigation system as defined in claim 1, further comprising the step of:
reading out the map data from the memory and multiplying a map scale value which is smaller than one, thereby shrinking the map image on the screen.

4. A display method for a navigation system as defined in claim 3, further comprising the step of:
reading out additional map data from the map data storage when the map data stored in the memory is insufficient.

5. A display method for a navigation system as defined in claim 3, further comprising the steps of:
reading out additional map data from the map data storage when the map data stored in the memory is insufficient;
converting the additional map data with respect to the screen coordinates;
combining the map data from the memory and the converted additional map data; and
displaying the map image encompassing a larger area than that covered by the original map image.

6. A display method for a navigation system as defined in claim 1, wherein said memory is a buffer memory or a map memory that is able to temporarily store the map data retrieved from the map data storage.

7. A display method for a navigation system as defined in claim 1, wherein said map data storage is a CD-ROM (compact disc read only memory), DVD (digital versatile disc), or a hard disc which stores map information for conducting operations for the navigation system.

8. A display method for a navigation system as defined in claim 1, wherein said step of zooming the map image includes a step of positioning an area of interest on the map image to the center of the screen.

9. A display method for a navigation system as defined in claim 1, further comprising the steps of:
positioning an area of interest on the map image to the center of the screen;
zooming-in the map image to a degree that new information for selecting a destination is displayed on the screen; and
selecting the destination using the new information on the screen to calculate a route to the destination.

10. A display method for a navigation system as defined in claim 9, wherein said new information includes POI (point of interest) icons showing positions and categories of POIs on the screen.

11. A display apparatus for a navigation system, comprising:
means for reading out map data from a map data storage for displaying a map image on a screen of a navigation system;
means for converting the map data to screen coordinates so that an intended map image is displayed on a correct position on the screen;
means for zooming the map image by enlarging or shrinking distances of points on the map image relative to a center of the screen; and
means for storing the map data converted to the screen coordinates in a memory for use with a further operation of changing the map scale.

12. A display apparatus for a navigation system as defined in claim 11, further comprising:
means for reading out the map data from the memory and multiplying a map scale value which is larger than one, thereby enlarging the map image on the screen.

13. A display apparatus for a navigation system as defined in claim 1, further comprising:
means for reading out the map data from the memory and multiplying a map scale value which is smaller than one, thereby shrinking the map image on the screen.

14. A display apparatus for a navigation system as defined in claim 13, further comprising:
means for reading out additional map data from the map data storage when the map data stored in the memory is insufficient.

15. A display apparatus for a navigation system as defined in claim 13, further comprising:
means for reading out additional map data from the map data storage when the map data stored in the memory is insufficient;
means for converting the additional map data with respect to the screen coordinates;
means for combining the map data from the memory and the converted additional map data; and
means for displaying the map image encompassing a larger area than that covered by the original map image.

16. A display apparatus for a navigation system as defined in claim 11, wherein said memory is a buffer memory or a map memory that is able to temporarily store the map data retrieved from the map data storage.

17. A display apparatus for a navigation system as defined in claim 11, wherein said map data storage is a CD-ROM (compact disc read only memory), DVD (digital versatile disc), or a hard disc which stores map information for conducting operations for the navigation system.

18. A display apparatus for a navigation system as defined in claim 11, wherein said means for zooming the map image includes means for positioning an area of interest on the map image to the center of the screen.

19. A display apparatus for a navigation system as defined in claim 11, further comprising:
means for positioning an area of interest on the map image to the center of the screen;
means for zooming-in the map image to a degree that new information for selecting a destination is displayed on the screen; and
means for selecting the destination using the new information on the screen to calculate a route to the destination.

20. A display apparatus for a navigation system as defined in claim 19, wherein said new information includes POI (point of interest) icons showing positions and categories of POIs on the screen.
